(19) United States
(12) Patent Application Publication
(10) Pub. No.: US 2006/0002574 A1
(43) Pub. Date: Jan. 5, 2006

(54) Canal hearing device with transparent mode

(75) Inventors: Adnan Shennib, Dublin, CA (US); Ross G. Baker JR., Bellaire, TX (US); Ian M. Day, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: InSound Medical, Inc., Newark, CA (US)

(21) Appl. No.: 11/173,816

(22) Filed: Jul. 1, 2005

Related U.S. Application Data
(63) Continuation-in-part of application No. 09/949,158, filed on Sep. 7, 2001, now Pat. No. 6,914,994.

(51) Int. Cl. H04R 25/00

(52) U.S. Cl. 381/321

(57) ABSTRACT

Embodiments of the invention provide a canal hearing device and method in which the device is implemented with a mode of operation that provides acoustic transparency as well as a power-saving function, permitting the user to wear the device in the ear canal during periods of sleep or inactivity without substantial loss of normal unaided response. The transparent mode has an in-situ acoustic transfer function that compensates for the insertion loss caused by the presence of a hearing device in the ear canal. While the device is in this transparent mode, its acoustic transfer function gives the user a perception of unaided hearing, as though the device were removed, when it is actually being worn continuously in the ear canal. Current drain of the device is significantly reduced as the transparent mode serves to shut off or reduce bias currents of at least one circuit element within device circuitry.

### CROSS-REFERENCES TO RELATED APPLICATIONS

This application is a continuation-in-part of U.S. patent applications Ser. No. 09/949158, filed Sep. 17, 2001, titled “Canal Hearing Device With Transparent Mode” which is fully incorporated herein by reference.

### BACKGROUND OF THE INVENTION

Embodiments of the invention relate to miniature hearing aids, acoustic and otherwise, which are fitted in the ear canal.

Conventional hearing aids provide sound amplification selected based on individual hearing loss. It is well known in the field of hearing aids that turning such devices OFF while being worn in the ear causes additional hearing loss to the wearer. This loss, referred to sometimes as “insertion loss”, occurs due to the occlusion of the ear canal by the hearing device. This occlusion prevents sounds from reaching the eardrum directly via the ear canal (see e.g., Sandlin, Hearing Instrument Science & Fitting Practices, National Institute for Hearing Instruments Studies, 1996, pp. 358).

It is also well known in the field of hearing aids that the unoccluded (open) ear canal (1 in FIG. 1) contributes significantly to the acoustic modification which occurs when sound (2) travels to the eardrum (4). This transfer function, sometimes referred to as Real-Ear Unaided Response (REUR) which includes the canal resonance, provides acoustic amplification at certain frequencies, generally in the range of 2000 to 4000 kHz (see e.g., Chasin M., Completely In The Canal Handbook, Singular Publishing, 1997, pp. 91). However, the occlusion by an in-situ hearing device in the OFF condition dramatically alters both the quality of incoming sound (altered frequency response-muffled) as well as its quantity (attenuation).

For the above reasons, a hearing aid is typically either worn with amplification ON, or removed from the ear and turned OFF for conserving battery power. It is conceivable that a hearing device may be worn OFF for achieving sound attenuation with the device acting essentially as an earplug. However, this is clearly not a desirable scenario for the hearing impaired who already suffer from hearing loss and cannot afford the additional loss. An acoustic vent across a hearing device is typically employed in conventional aids for variety of reasons including allowing certain frequency ranges to bypass the device and reach the eardrum via the vent. However, venting is useful mainly in conjunction with amplification provided by the ON in-situ device. Hence, vents do not substitute for the natural unaided response when an in-situ device is in the OFF condition.

More practical means of reducing current consumption, without resorting to shutting of the device, include volume reduction. However, volume reduction does not reduce power consumption proportional to the reduction nor does it restore the natural perception of unaided hearing.

Reducing the power consumption has always been a major goal in hearing aid design. In programmable hearing aids, for example, circuit elements can be selectively turned off depending on the operating condition required by the user. Martin et. al. for example, in U.S. Pat. No. 5,710,820 describe a hearing aid in which “function blocks not required for the selected operating condition are deactivated and bridged (cut out), so that only the current respectively required for the active function blocks is drawn from the battery 35.”

Recent advances have lead to the development of extended-wear (semi-permanent) canal hearing devices, which are operated continuously in the ear canal for several months before battery depletion and removal. These canal hearing devices are totally inconspicuous thus cosmetically appealing to the users. Turning these extended-wear devices OFF during sleep or inactivity is desirable on one hand for reducing power consumption and extending the battery life of the device. However, turning these devices OFF in-situ causes an insertion loss as described above. The insertion loss is problematic for these users since it further limits their hearing ability, particularly in emergency situations (fire alarm, horn blowing, traffic sounds, etc.). Another problem caused by the insertion loss of hearing aids in general is the inability to hear sounds naturally in a similar manner as in the unaided condition. Removal of the extended-wear devices to restore unaided hearing contradicts the intended purpose of their continuous wear.

There a need is to provide a canal device and a method thereof for reproducing the unaided response while the hearing device is worn in the ear canal. There is also a need to significantly reduce the power consumption of a canal hearing device in-situ while simultaneously producing the experience of unaided hearing.

### BRIEF SUMMARY OF THE INVENTION

Embodiments of the invention provide systems, apparatus, devices and methods for hearing assistance which utilize an acoustic transparency mode of operation. Such embodiments are particularly suited for use with in the canal hearing devices during sleep or inactivity. Acoustic transparency is accomplished by providing an in-situ acoustic transfer function that compensates for the insertion loss caused by the presence of a hearing device in the ear canal. The transparent mode simulates the user's experience of unaided hearing, thus causing the user to perceive the acoustic “absence” of a hearing device while a device is worn in the ear canal.

Various embodiments of the invention having the acoustic transparency mode also provide a power saving mode of operation for a hearing device in that the acoustic transparency mode significantly reduces the current drain from the battery thus extend the life of the battery and the hearing device. In various embodiments, current reduction can achieved by shutting off one or more circuit elements of the hearing device and/or by reducing bias currents to other elements.

Embodiments of the invention provide methods and devices for reproducing the unaided hearing function while providing significant power savings without resorting to removing the hearing device from the ear canal. Such embodiments allows the user to continue to hear and thus respond to audible alarms (e.g. fire, etc), traffic sounds and/or other sounds indicative of emergency situations as if the device were not present in the ear canal. Embodiments of the invention are particularly applicable for extended wear applications in which a specialized hearing device is worn continuously in the ear canal for several months without daily removal. Embodiments of the invention are also applicable for use with disposable hearing devices to improve device operational life. Such embodiments utilize the acoustic transparent mode to extend the life of an integrated battery and thus the hearing device. Specific embodiments provide a disposable hearing device with acoustical transparent mode capabilities and an operation life of three to six months or longer.

Still other embodiments provide a hearing aid device having acoustic transparency mode functionality wherein the device includes circuitry or other logic resources to switch between a transparency mode and a full gain mode and/or other ON modes responsive to one or more inputs such as levels of ambient noise or external acoustic stimuli such as alarm sounds or externally amplified sounds (e.g. via loud speakers etc). In specific embodiments, the device can be configured to switch modes from an ON mode to a transparency mode responsive to specific decibel level of sound (e.g., a 80 to 110 dB). Such embodiments provide a means for automatically and rapidly switching modes to protect the user from exposure to over-amplification of loud sounds without requiring the user to make the adjustments.

Another embodiment provides a device for protecting a wearer's hearing against damaging sounds. The device causes an acoustic insertion loss when placed in or over an ear canal of the wearer in an OFF condition and produces an acoustic gain compensating for the insertion loss when powered in an ON condition. The device comprises a microphone, circuitry, a power source and acoustic transparency means. The acoustic transparency means are configured for selectively producing an in-situ acoustic transfer function substantially compensating for the acoustic insertion loss to create an acoustic perception to the wearer of unaided hearing response despite a continued presence of the protective device in or over the ear canal. The device can also comprise means for switching between the OFF condition and the ON condition responsive to at least one of an input, a wearer input or an acoustic input. The power source can include a battery, capacitor or other electrical energy storage device.

Still another embodiment provides an apparatus configured to be worn in or over an ear canal of a wearer. The apparatus comprises a body configured to be placed in or over the ear canal, a microphone, circuitry and a power source. The body causes an acoustic insertion loss when in or over the ear canal when the apparatus is in an OFF condition. When the apparatus is an ON condition, the circuitry utilizes an in-situ acoustic transfer function substantially compensating for the acoustic insertion loss to create an acoustic perception to the wearer of an unaided hearing response despite a continued presence of the body in or over the ear canal. The circuitry is also configured to switch between the ON condition and the OFF condition responsive to at least one of an input, a wearer input or an acoustic input.

### BRIEF DESCRIPTION OF THE DRAWINGS

The above and still further features and aspects of the present invention will be better understood from the following detailed description of the best mode presently contemplated for practicing the invention, with reference to certain preferred embodiments and methods, taken in conjunction with the accompanying Figures of drawing, in which:

FIG. 1 is a view of the ear canal occluded with a deep canal hearing device;

FIG. 1A is a view of the ear with a hearing protection device;

FIG. 2 is a schematic diagram of an analog amplifier embodiment of the hearing device of the present invention; and

FIG. 3 is a schematic diagram of digital-signal-processing embodiment of the invented hearing device.

### DETAILED DESCRIPTION OF THE INVENTION

Various embodiments of the invention provide hearing aid devices, apparatus and methods which utilize an acoustically transparent mode of operation. This mode of operation is achieved through the use of an in-situ acoustic transfer function that compensates for the insertion loss caused by the presence of a hearing device in the ear canal. The transparent mode simulates the user's experience of unaided hearing, thus causing the user to perceive the “absence” of a hearing device while a device is worn in the ear canal. This mode is particularly useful during wearer inactivity, such as during sleeping. Thus the mode is referred to below sometimes as sleep mode.

The transparent mode can significantly reduce current drain from the hearing aid battery and thus serves to extend the life of the battery and the hearing device. Current reduction is achieved by shutting off one or more circuit elements and/or by reducing bias currents to other elements. Various embodiments of the invention using the acoustic transparency mode can restore the unaided hearing function of the ear while the hearing device remains in place in the ear. They also provide significant power savings by reducing the current drain on the battery.

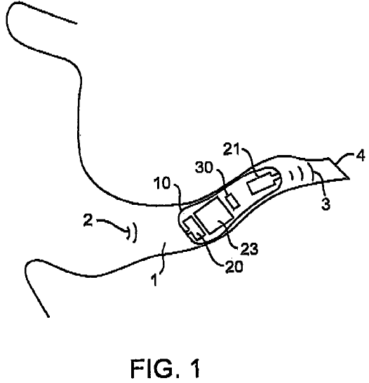

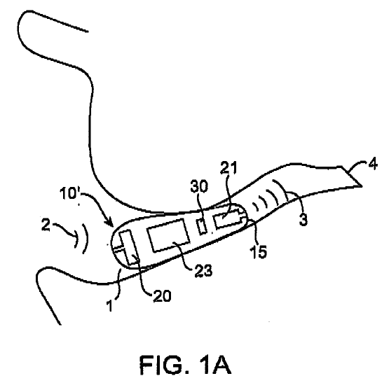

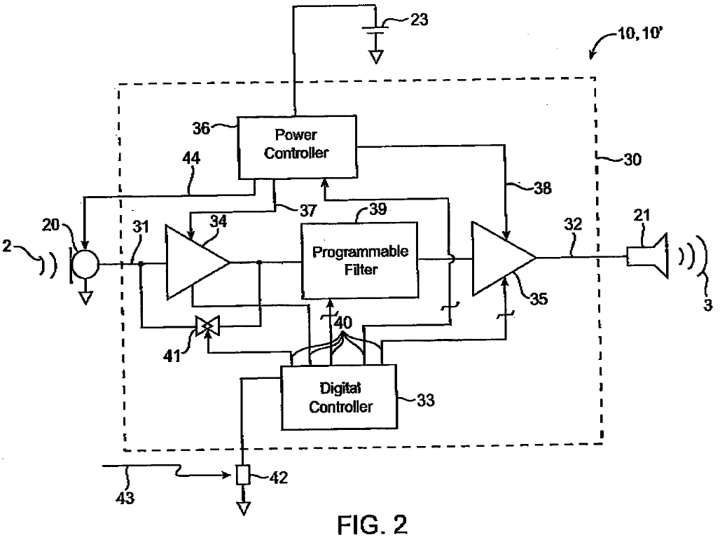

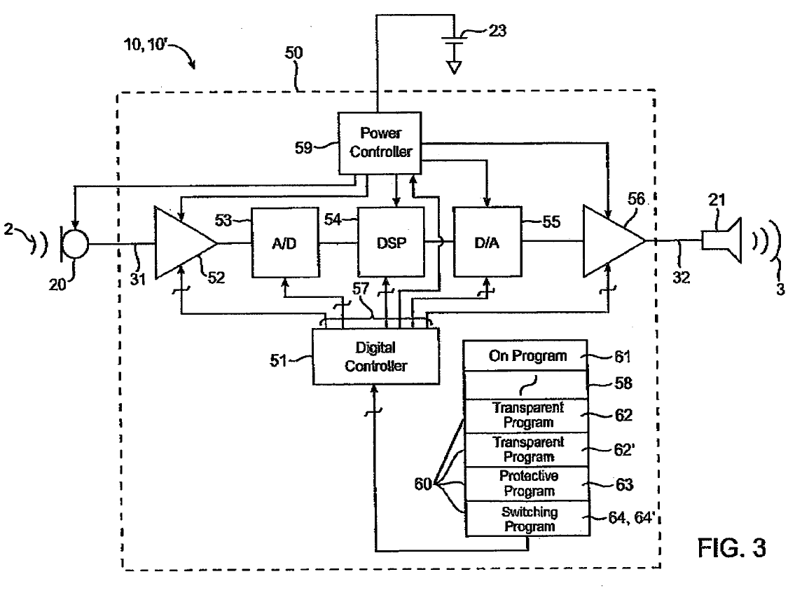

Embodiments of invention, illustrated in FIGS. 2 and 3, provide a hearing enhancement or other hearing device 10 configured to be placed in the ear canal 1. In the exemplary embodiments shown in FIGS. 2 and 3 (and with further reference to FIG. 1), the canal hearing device 10 comprises a microphone 20, a receiver (speaker) 21, battery 23, and integrated circuitry 30 (50 in FIG. 3). The microphone picks up incoming sound 2 and receiver 21 delivers amplified sound 3 to the eardrum 4. Integrated circuitry 30 can include or otherwise be incorporated into logic resources such as a processor or ASIC as described below.

In the analog embodiment of FIG. 2, integrated circuit 30 comprises circuit elements including input amplifier 34 and output amplifier 35, for amplifying microphone output 31 and producing amplified receiver input 32. Amplifiers 34 and 35 are biased via bias lines 37 and 38, respectively, from current sources within power controller circuit 36. Digital controller 33 provides control signals 40 to input amplifier 34, output amplifier 35, programmable filter 39, and power controller circuit 36. The amplification and filter settings are programmed into digital controller 33 by means well known in the field of hearing aid design. This includes wire and wireless programming methods which load a program setting (prescription) into memory elements (not shown) associated with digital controller 33. The programming of the embodiment of FIG. 2 is accomplished via a magnetic switch 42 activated by an external magnetic field 43 produced by a magnet held by the user, for example. The user, using a magnet or other wireless programming device and methods known in the field, selects the transparent mode or other modes such as ON or OFF mode, as desired. Other suitable wireless devices and methods can include Rf devices using e.g., BLUETOOTH or WIFI protocols and infrared devices using an IRDA protocol. The prescription can be selected according to specific amplification and filtering needs of the hearing impaired individual. In specific embodiments, the hearing device can be configured to switch from a sleep mode to an ON or other mode responsive to an external wireless signal sent as a result of an alarm (e.g. a home fire alarm) or other event (e.g. a phone call). For example a home fire alarm could be programmed to send/broadcast a wireless signal to the hearing device upon activation of the alarm.

In various embodiments, wireless devices and methods can be used to enter one or more new programs which contain instructions for updated prescriptions, modifications to existing prescription, new modes of operation, or modifications to existing modes of operation. In this way, the user can wirelessly reprogram their hearing device as their hearing assistance need change over time or depending upon the acoustic environment. In specific embodiments, the user can wirelessly reprogram different modes or levels of transparency depending upon the acoustic environment. For example, there can be one transparency mode for user sleeping, others for indoor environments and still others for outdoor environments.

In the normal ON operation, bias currents from bias lines 37 and 38 are relatively high. This is due to the relatively high amplification (gain) requirement of the hearing device 10. However, when the digital controller 33 is appropriately invoked by the user, the control signals 40 are switched to reflect the transparency mode. This causes the power controller to reduce bias currents substantially since the gain requirements are relatively lower than ON gain requirements. Furthermore, input amplifier 34 is preferably completely shut off (zero bias current from bias line 37) during the transparency mode in the embodiment of FIG. 2. In this case, the microphone output 31 is switched directly to programmable filter 39 input via analog switch 41. Bias current to the microphone 20 via microphone bias line 44 is also reduced during sleep mode of the present invention.

FIG. 3 illustrates a digital signal processing embodiment of the invented hearing device 10 comprising microphone 20, receiver 21, battery 23 and integrated circuit 50. In this embodiment, digital controller 51 defines the settings for circuit blocks via control lines 57 connected to pre-amplifier 52, analog-to-digital (AID) converter 53, digital signal processor (DSP) unit 54, digital-to-analog (D/A) converter 55 and output amplifier 56. Suitable digital controllers can include processors, RISC-based processors, ASICS and other logic resources known in the art. A memory element 58 may comprise or otherwise store various prescriptions, individualized or generalized in the form of software programs or electronic instruction sets 60, also referred to as modules 60. Suitable memory elements can include ROM, EPROMs RAM, DRAMs and the like and other memory resources known in the art. Programs 60 stored in memory element 58 can comprise an ON Program 61 and a Transparent Program 62 for on and sleep modes, respectively. Programs 60 can also be stored in other memory resources (not shown) coupled to controller 51. Transparent program 62 can comprise several different transparent programs 62′ from which the user can select (e.g., one for sleeping and others for indoor and outdoor environments, etc) using wireless programming methods described herein. Other programs 60 can include Protective Program 63 for a protective mode where the hearing device is off and provides no amplification. Such protective modes can also be incorporated into hearing protection devices described herein that include transparent mode functionality.

Digital controller 51 is configured to execute one or more programs 60 (e.g., ON Program 61, Transparent Program 62, etc) stored in memory element 58 or other memory resources coupled to controller 51. In specific embodiments, controller 51 can be configured to execute one or more programs 60, such as transparent program 62 using a multi-thread programming architecture described below. The digital controller 51 also controls the power controller 59 to affect bias currents of circuit blocks depending on the desired mode of operation. For example, the controller can decrease the level of bias current when in the sleep mode.

Memory element 58 (or other memory resources coupled to controller 51) can also include a switching program 64 configured to switch between a Transparent Program, an ON Program and an OFF mode (e.g. no amplification) responsive to an input, either user or external (e.g., levels of ambient sound). In various embodiments, digital controller 51 can be configured to run program 64 concurrently to the other programs or modules 60 using multi-thread, multi-tasking or similar programming methodology. Thus in one embodiment, controller 51 can be running transparency program 62 as one thread and switching program 64 as another thread. Alternatively, program 64 can be incorporated as a subroutine 64′ or module in one or more of the other programs.

In each of these embodiments, the sleep (transparent) mode of the device is preset to produce an in-situ response substantially similar to the unaided response (i.e., mirroring the response that would be perceived by the hearing of the impaired individual if no hearing device were present in the ear canal). Thus, the wearer receives the benefit of being able to leave the device in place in the ear, without experiencing the occlusion that would otherwise be present if embodiment of the transparent mode were not provided in the hearing device. The transparent mode is particularly desirable for extended wear canal hearing devices, which are worn continuously in the ear canal for several months or longer without daily removal. Since the user does not remove the device from the ear on a daily basis, as he or she would with conventional hearing aids, the transparent mode allows the user to perceive sounds as though they were “unaided,” and allows the device to conserve energy to enable extended wear. The transparency mode is particularly suitable during sleep and resting, since it is during those times that users of conventional hearing aids generally prefer to remove the device from the ear to avoid prolonged and unnecessary amplification, and consequent noise-induced fatigue and irritation. Turning an in-situ device OFF for extended wear applications causes insertion loss which interferes with communications and further presents a potential hazard during emergency situations (i.e., fire alarm, traffic, etc.).

In the preferred embodiments, however, the aided response in the transparent mode can be adjusted or preset to yield an overall response in-situ substantially similar to the unaided response. In those embodiments, the aided response in the sleep mode can be within 6 decibels (db) of the unaided response, particularly in the sound range of 125 to 4,000 Hertz (Hz). The prescription of the device depends on the position of the device in the ear canal, and particularly the distance and air volume between the receiver 21 and eardrum 4 (FIG. 1). Theses factors can be used in determining the settings for the sleep mode. In various embodiments, the sleep mode prescription for a particular device may be: i) generic, ii) based on a generalized ear model; or iii) it may be specific to the user, based on measured unaided and aided responses or other audiometric test known in the art. Also the prescription can be a combination of a generic and individual settings. In still other embodiments, the level of sleep mode prescription can be set based on of the ambient sound levels in the wearer's environment. For example, the sleep mode gain can be set lower for environments having higher levels of ambient sound and lower for the contrary. The device itself can be configured through programming (e.g. programs 60) or other electronic control means to dynamically adjust the sleep mode prescription based on measurement of the ambient sound. Further, the device can configured to switch between a sleep mode and an ON mode or other mode based on the level of ambient sound.

In a specific embodiments determination of the sleep mode settings can be made using a hand held hearing evaluator such as that described in U.S. patent application Ser. No. 09/400,151 (filed Sep. 21, 1999) which is fully incorporated by reference herein. In such embodiments, the personal hearing evaluator can be used to conduct an audiometric test record a result (e.g. via user input of perceived loudness at one or more test frequencies), calculate one or more sleep mode settings and then signal the settings to the hearing aid using wireless methods described here or known in the art. Alternatively, the hearing evaluator can be configured to display the settings and/or download or otherwise signal them to a computer other processor means configured to communicate with the hearing device.

Various embodiments of the transparent mode are also applicable for use in other types of hearing devices such as disposable hearing aids with an integrated battery. In such applications, the hearing device is disposed of when its integrated battery is depleted. The transparent mode improve the longevity of the disposable device, thus reducing the cost of replacement over time. Embodiments of the invention using the transparency mode are also applicable to extended wear canal devices using alternate transducers such as a direct tympanic drive. An example of an direct tympanic drive is described in U.S. Pat. No. 6,137,889) which is fully incorporated by reference herein.

In other embodiments, the transparent mode can be incorporated into a hearing protection device 10′ such as earplugs, protective head phones and the like. In the exemplary embodiments shown in FIGS. 1A, 2 and 3 (and with further reference to FIG. 1A), hearing protection device 10′ can comprise a body 15 and a microphone 20, a receiver (speaker) 21, battery 23, and integrated circuitry 30 (50 in FIG. 3) the later components being disposed in, on or otherwise coupled to the body. Body 15 can have sufficient acoustical attenuation properties so as to provide protection to the ear of the wearer against high amplitude, loud or other damaging or annoying sounds. Body 15 can comprise sound attenuating foam or other complaint material known in the art. In various embodiments, body 15 can be configured to be worn in, on or over ear canal 2. In one embodiment body 15 can be configured to be worn in the ear canal, in another, it can placed partially in the canal and partially out, and in still another it can placed entirely outside of the canal.

Similar to device 10, the transparent mode can be incorporated into protection device 10′ via one or more programs 60 stored in memory element 58 and executed by controller 51 or other electronic control means known in art. In such embodiments, the hearing protection device 10′ can be configured to monitor ambient sound levels and switch from a transparent mode (corresponding to program 62) to a Protective mode (corresponding to program 63) responsive to a sound threshold such as may be produced from heavy machinery, aircraft engines, amplified music or gunshots. Example threshold switching levels include levels of 60 dB or higher with specific embodiment of 70, 80, 85, 90, 100, 110 and 120 dB. In related embodiments, protective device 10′ can be configured to switch into the protective mode responsive to a rate of change in the ambient sound level. Example rates of change for switching can include rates of change of 10 to 100 dB per second with specific embodiments of 25, 50 and 75 dB per second. The monitoring and switching can be performed by an integral monitoring and switching program 64 or by separate programs. The settings for the transparent mode can also be set depending upon the ambient acoustic environment or desired sounds to be heard. For example, one transparent mode can be configured for hearing normal speech, another for shouted speech and still another for hearing one or more audible alarms (e.g. fire alarm, klaxon sounds, etc.). Further, various embodiments of the transparent mode can include hybrid modes configured to provide a degree of hearing protection while allowing the user to hear certain desired sounds such as shouted commands. The user can select between partially and fully transparent mode using wireless programming methods and devices described herein. The selection of the mode can also be implemented by a switching program described herein. In specific embodiments, the transparent mode can be configured to function as high pass or low pass acoustic filter to amplify certain frequencies of sound (e.g. those corresponding to the human voice) while filtering out others such as those associated with machinery, aircraft engine noise, construction equipment or ultrasonic equipment. In still other embodiments, the switching program 64 can be configured to switch from an ON mode to a Transparent mode to conserve battery power. In these embodiments controller 51 and/or program 64 can be configured to monitor battery voltage and/or current switch to the transparence mode when the voltage or current falls below a preset or selected level. The hearing device can be configured to give the user an identifying audible alarm indicating that the device has switched modes due to battery power levels or other reasons. The alarm can also be used when the user manually selected the transparent mode to let the user know that a desire mode selection has been made.

In use, the above embodiments provide a hearing protection device with a transparency mode that allows a user to hear conversation and other normal levels of ambient sound or even alarms while being afforded protection from potentially damaging or other loud or annoying sounds. Such devices allow the user to still communicate and discern important sound when working in high noise environments such as around aircraft, construction sites, trains, firing ranges or in military situations.

Five prototypes of canal hearing devices currently under development by InSonus Medical Inc. (Now Insound Medical Inc. assignee of the present invention) were evaluated in terms of current consumption during various modes of operation; namely Full-ON-Gain (FOG) mode, typical ON mode, and transparent mode. FOG mode represents the maximum gain settings available for the device. Typical ON mode represents typical gain settings for the average user, and transparent mode represents a setting offering functional gain generally within 6 decibels of unaided response in the standard audiometric frequency range. The transparent mode causes the hearing device to reduce bias currents to the microphone 20 (FIG. 2) and output amplifier 35. Furthermore, bias current is essentially shut off for input amplifier 34 while the microphone output 31 is switched directly to the input of output amplifier 35. These reductions lead to substantial current savings in the transparent mode as is shown below.

Each of the canal device prototypes comprises a proprietary ultra-low power integrated circuit 30 (model DS-I) according to the embodiment of FIG. 2. The device prototypes were tested using standard hearing aid analyzer equipment (model Fonix 6500 CX manufactured by Frey Electronic) and a standard CIC (Completely-In-the-Canal) coupler simulating the ear canal cavity. The current consumption was measured using a laboratory digital meter (model PROTEK 506).

The current consumption in the FOG, ON and transparent modes was 65.9 microamperes (μA), 40.3 to and 5.8 μA, respectively, on average for the five prototypes.

The transparent mode reduces power consumption by approximately 91% of maximum settings and by 85% of typical settings.

### CONCLUSION

The foregoing description of various embodiments of the invention has been presented for purposes of illustration and description. It is not intended to limit the invention to the precise forms disclosed. Many modifications, variations and refinements will be apparent to practitioners skilled in the art. Further, the teachings of the invention have broad application in the hearing aid device fields as well as other fields which will be recognized by practitioners skilled in the art.

Elements, characteristics, or acts from one embodiment can be readily recombined or substituted with one or more elements, characteristics or acts from other embodiments to form numerous additional embodiments within the scope of the invention. Also, elements that are shown or described as being combined with other elements in some embodiments, can in various embodiments, exists as stand alone elements. Hence, the scope of the present invention is not limited to the specifics of the exemplary embodiment, but is instead limited solely by the appended claims.

What is claimed is:

1. A canal hearing device for hearing enhancement to a user, the device comprising:
a microphone, an integrated circuit, and a power source; and an improvement comprising:
an acoustic transparent mode of operation of said canal hearing device having an overall in-situ acoustic transfer function that gives the user a perception of unaided hearing while said canal hearing device is being worn in the ear canal, said transparent mode being selectable by the user.

2. The canal hearing device of claim 1, wherein said transparent mode includes means for selectively reducing current drain of said canal hearing device.

3. The canal hearing device of claim 2, wherein said means for selectively reducing current drain reduces at least one bias current of a circuit element within said integrated circuit.

4. The canal hearing device of claim 2, wherein said means for selectively reducing current drain shuts off at least one circuit element within said integrated circuit.

5. The canal hearing device of claim 1, wherein said overall in-situ transfer function is within approximately 6 decibels of unaided hearing.

6. The canal hearing device of claim 1, wherein said in-situ acoustic transfer function of said transparent mode is selectable according to said user.

7. The canal hearing device of claim 1 wherein said canal hearing device is an extended-wear device adapted to be worn continuously in the ear canal for longer than one month.

8. A canal hearing device for hearing enhancement, said hearing device causing an acoustic insertion loss when placed in the ear canal of a wearer in an OFF condition and normally producing an acoustic gain substantially greater than said insertion loss when powered in an ON condition, said hearing device comprising:
a microphone, circuitry and a power source; and
acoustic transparency means for selectively producing an in-situ acoustic transfer function substantially compensating for said acoustic insertion loss to create an acoustic perception to the wearer of said hearing device of unaided hearing response despite a continued presence of said hearing device in the ear canal.

9. The canal hearing device of claim 8, wherein said acoustic transparency means produces an in-situ aided response within about 6 decibels of unaided response.

10. The canal hearing device of claim 8, wherein said acoustic transparency means selectively reduces at least one bias current of a circuit element within said circuitry.

11. The canal hearing device of claim 8, wherein said acoustic transparency means shuts off at least one circuit element within said circuitry.

12. The canal hearing device of claim 8, wherein said in-situ acoustic transfer function is programmable to accommodate the individual wearer.

13. The canal hearing device of claim 8, wherein said canal hearing device is an extended-wear device adapted to be worn continuously in the ear canal for at least one month.

14. The canal hearing device of claim 8, wherein said power source is a battery, and
said canal hearing device is disposable, adapted to be discarded when said battery is depleted.

15. An device for protecting a wearer's hearing against damaging sounds, the device causing an acoustic insertion loss when placed in or over an ear canal of the wearer in an OFF condition and producing an acoustic gain compensating for the insertion loss when powered in an ON condition, the device comprising:
a microphone, circuitry and a power source;
acoustic transparency means for selectively producing an in-situ acoustic transfer function substantially compensating for the acoustic insertion loss to create an acoustic perception to the wearer of the hearing device of unaided hearing response despite a continued presence of the protective device in or over the ear canal; and
means for switching between the OFF condition and the ON condition responsive to at least one of an input, a wearer input or an acoustic input.

16. An apparatus configured to be worn in or over an ear canal of a wearer, the apparatus comprising:
a body configured to be placed in or over the ear canal; the body causing an acoustic insertion loss when so placed when the apparatus is in an OFF condition; and
a microphone, circuitry and a power source; wherein when the apparatus is an ON condition, the circuitry utilizes an in-situ acoustic transfer function substantially compensating for the acoustic insertion loss to create an acoustic perception to the wearer of an unaided hearing response despite a continued presence of the body in or over the ear canal, the circuitry configured to switch between the ON condition and the OFF condition responsive to at least one of an input, a wearer input or an acoustic input.

17. A method of rendering a canal hearing device acoustically transparent in use, wherein said canal hearing device comprises a microphone, circuitry and a power source, and normally produces an acoustic insertion loss while powered OFF when in the ear canal of a user and an acoustic gain substantially greater than said insertion loss when powered ON, the method comprising:
implementing said canal hearing device with a selectable acoustic transparency mode of operation that produces an in-situ acoustic transfer function to compensate for said acoustic insertion loss, and thereby simulate to the user an absence of said canal hearing device despite its continued presence in the ear canal; and
providing said canal hearing device with means to enable the user to select said acoustic transparency mode of operation.

18. The method of claim 17, further comprising:
implementing said acoustic transparency mode to produce said in-situ acoustic transfer function within about 6 decibels of unaided response.

19. The method of claim 17, further comprising:
rendering said acoustic transparency mode to be programmable so that its in-situ acoustic transfer function may be programmed to accommodate the individual user.

20. The method of claim 17, further comprising:
implementing said acoustic transparency mode to reduce bias current for at least one circuit element within said circuitry.

21. The method of claim 17, further comprising:
implementing said acoustic transparency mode to shut off bias current for at least one circuit element within said circuitry.

22. The method of claim 17, further comprising:
adapting said canal hearing device for extended wear continuously in the ear canal for a period of time of at least one month.
